(19) United States
(12) Patent Application Publication
(10) Pub. No.: US 2013/0042012 A1
(43) Pub. Date: Feb. 14, 2013

(54) Multi-Headed Thin Client

(71) Applicants: Richard Lewis, Lynnwood, WA (US); Jack Creasey, Redmond, WA (US); Neil Fishman, Redmond, WA (US); Clark D. Nicholson, Seattle, WA (US)

(72) Inventors: Richard Lewis, Lynnwood, WA (US); Jack Creasey, Redmond, WA (US); Neil Fishman, Redmond, WA (US); Clark D. Nicholson, Seattle, WA (US)

(73) Assignee: MICROSOFT CORPORATION, Redmond, WA (US)

(21) Appl. No.: 13/206,482

(22) Filed: Aug. 9, 2011

(51) Int. Cl. G06F 15/16

(52) U.S. Cl. 709/228

(57) ABSTRACT

Images from web pages may be classified based on the text associated with the images. A system for identifying and classifying images may identify one or more web pages containing the image, determine topics from the text of the web pages, and develop a set of training phrases for a classifier. The classifier may be trained, then used to analyze the text in the web pages. The training set may include both positive examples and negative examples of text taken from the website. A positive example may include captions or other elements directly associated with the image, while negative examples may include text taken from the web page, but from a large distance from the web page. In some cases, the system may iterate on the classification process to refine the results.

### BACKGROUND

Computer hardware resources are expensive and often underutilized. A typical personal computer may often be idle for long periods of time, even when a user may be actively using the computer. For many environments, such as education and business uses, the cost of having a computer on each student's or worker's desk may be very high.

### SUMMARY

A multi-headed thin client may have multiple user interfaces and may present separate sessions to each user interfaces. A single computer system may have multiple input devices, such as keyboards, mice, game controllers, or other devices, and multiple monitors or monitor portions. The groups of user interface devices may be assigned to individual sessions, each of which may be separate and distinct from each other, and each of which may be served by separate session servers. The hardware user interface devices may include a hub or other connection point where a user may connect various peripheral devices, and communications with the devices may be routed to and from the session server.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a network environment in which a multi-headed thin client may operate.

FIG. 2 is a diagram illustration of an embodiment showing a schematic operation of multi-headed thin client device.

FIG. 3 is a flowchart illustration of an embodiment showing a method for configuring and operating a multi-headed thin client.

### DETAILED DESCRIPTION

A multi-headed thin client system may present separate user interfaces served by remote session servers to multiple users. The system may have separate hardware user interface devices, each of which may present an independent computer session to a user.

In a typical embodiment, a single system may have two or more sets of input devices, such as keyboards, pointing devices, game controllers, or other input devices. The system may have multiple output display devices, such as computer monitors or other display devices. In some embodiments one or more display devices may be shared between two or more users.

Each session may be controlled by a remote session server, where the remote session server may receive inputs from the input devices and generate output that may be displayed by the display devices. The thin client system may pass inputs and outputs from the user interface hardware to and from the session servers. In some embodiments, the communications with the session servers may be compressed or encrypted.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

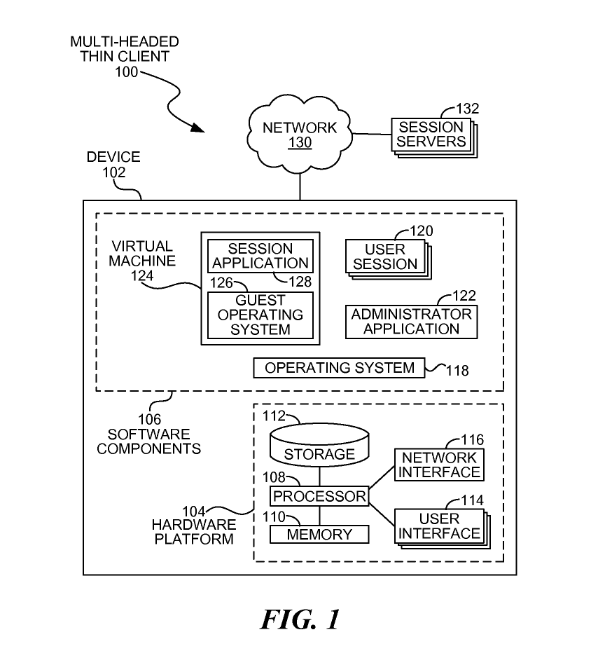

FIG. 1 is a diagram of an embodiment 100, showing a multi-headed thin client. Embodiment 100 is a simplified example of a computer system that may have multiple, independent user stations, each of which may access another device through which may provide a remote session.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is a simplified example of a hardware and software device that may have multiple user stations through which multiple users may access computer sessions on other computers. The device 102 may have several user stations, which may consist of input and output devices that may be assigned to a user.

In one example use scenario, a single device 102 may have four or six user stations, each of which may have a keyboard and a pointing device, such as a mouse, and each of the user stations may have a separate monitor. In some embodiments, the monitors or other devices may be mapped partially to one user station and partially to another user station. In one such embodiment, a single monitor may be partitioned into halves, where each half may be assigned to a different user. In another such embodiment, a single monitor may be divided into four or more sections, each of which may be assigned to a different user station.

In another use scenario, a gaming console may have two, three, four, or more user controllers, each of which may be assigned to different user stations that may be displayed on a single monitor. Each of the user stations may be mapped to a separate session computer which may accept user input and generate output, where the output may be displayed on a portion of the monitor.

The device 102 may operate as a thin client for multiple computer sessions, each of which may operate separately and independently from each other. In a typical user experience, each user may appear to interact with and operate a separate computer system. In such a user experience, the user may interact with a set of user input devices and user output devices connected to the device 102, but the inputs may be received by a remote session server 132 to generate outputs that may be displayed on the device 102.

The device 102 is illustrated having hardware components 104 and software components 106. The device 102 as illustrated represents a conventional computing device, although other embodiments may have different configurations, architectures, or components.

In many embodiments, the device 102 may be a specialized computer device designed for multi-headed thin client operation. In some embodiments, the device 102 may still also be a server computer, desktop computer, laptop computer, netbook computer, tablet or slate computer, wireless handset, cellular telephone, game console or any other type of computing device.

The hardware components 104 may include a processor 108, random access memory 110, and nonvolatile storage 112. The hardware components 104 may also include a user interface 114 and network interface 116. The processor 108 may be made up of several processors or processor cores in some embodiments. The random access memory 110 may be memory that may be readily accessible to and addressable by the processor 108. The nonvolatile storage 112 may be storage that persists after the device 102 is shut down. The nonvolatile storage 112 may be any type of storage device, including hard disk, solid state memory devices, magnetic tape, optical storage, or other type of storage. The nonvolatile storage 112 may be read only or read/write capable.

The user interface devices 114 may be any type of hardware capable of displaying output and receiving input from a user. In many cases, the output displays may be graphical display monitors, although output devices may also include lights and other visual output, audio output, kinetic actuator output, as well as other output devices. Conventional input devices may include keyboards and pointing devices such as a mouse, stylus, trackball, game controller, or other pointing device. Other input devices may include various sensors, including biometric input devices, audio and video input devices, and other sensors.

The network interface 116 may be any type of connection to another computer. In many embodiments, the network interface 116 may be a wired Ethernet connection. Other embodiments may include wired or wireless connections over various communication protocols.

The software components 106 may include an operating system 118 on which various applications and services may operate. An operating system may provide an abstraction layer between executing routines and the hardware components 104, and may include various routines and functions that communicate directly with various hardware components.

The software components 106 may include an administrator application 122 that may configure several user sessions 120. Each of the user sessions 120 may connect one of the sets of user interface devices to a session server. The user sessions 120 may receive user input from user input devices associated with a session, transmit the user input to a session server, receive display information from the session server, and display the display information on a user output device.

The administrator application 122 may allow an administrator to set up the hardware of the device 102 for various user sessions. The user interface hardware may be grouped together into a set of user input devices and user output devices such that several users may separately access different session servers. In a typical use scenario, the sessions may be separate, independent sessions, where each user may experience operating a different computer system.

In some embodiments, one or more of the session servers may be local session servers. One such embodiment may have a locally executing virtual machine 124 that may have a guest operating system 126 on which a session application 128 may execute. The session application 128 may allow a remote user to experience executing applications on the guest operating system 126 using the user interface hardware 114. A user session 120 may facilitate the communications between the session application 128 and the user interface hardware.

In some embodiments, one or more of the session servers may be remote session servers 132. The remote session servers 132 may be accessed through a network 130. In some embodiments, the network 130 may be a local area network, a wide area network, the Internet, or other network. In some such cases, the session servers 132 may be located anywhere in the world.

When the session servers 132 are located over various networks, the connections between the user session 120 and a remote session server may be compressed. In some such embodiments, a session server 132 may compress output communications, such as video output, that may be decompressed at the device 102 before presentation on a video display. Some embodiments may or may not compress communications from the device 102 to the session servers 132.

In some embodiments, communications between the user session 120 may be encrypted. Encrypted communications may use various encryption mechanisms to encrypt some or all of the communications.

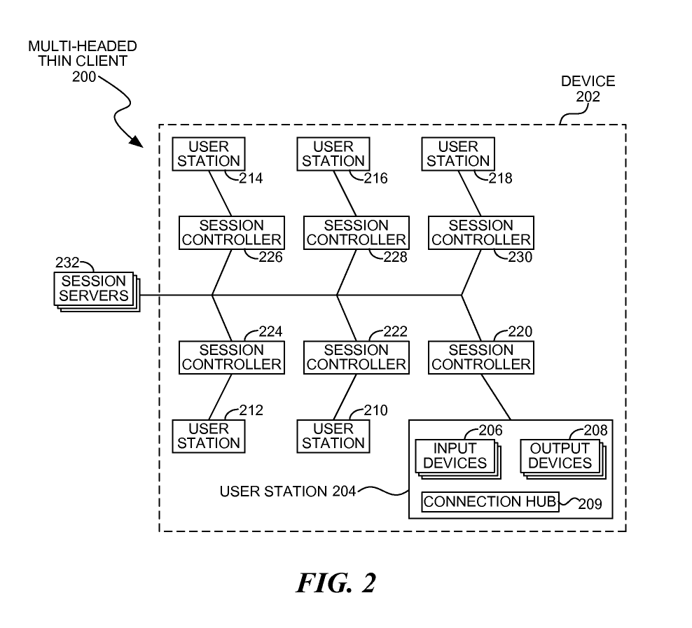

FIG. 2 is a diagram of an embodiment 200, showing a multi-headed thin client. Embodiment 200 is a schematic illustration of various functional components that may make up a multi-headed thin client device.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

The device 202 may have multiple thin client sessions with different session servers 232. Each thin client session may provide a user interface to a remote computer. The thin client session may provide minimal computer processing, and a bulk of the computer processing for each user session may be performed by the remote session servers.

The device 202 may have several user stations 204, 210, 212, 214, 216, and 218. An example user station 204 may include various input devices 206 and various output devices 208. In some cases, a user station 204 may have a connection hub 209.

In a conventional personal computer thin client, the user station 204 may have input devices 206 that may include a keyboard and pointing device such as a mouse, as well as output devices 208 that may include a display monitor. In some embodiments, the user input and output devices may include audio devices such as microphones and speakers, as well as video devices such as web cameras, video cameras, and video displays.

The connection hub 209 may have one or more connections for external devices. One such embodiment may be a Universal Serial Bus (USB) hub where a user may connect various peripheral devices to a session. The peripheral devices may be any type of device, such as a portable storage device, music player, cellular telephone, card reader, printer, scanner, web camera, hard disk storage system, or any other type of device.

In many embodiments, the connection hub 209 may be routed by the session controller 220 to detect devices as they are connected to the connection hub 209, then route the communications to a session server 232. The session server 232 may install a device driver for the newly connected device, and may communicate with the newly installed device to interact with the device.

In such an embodiment, the connection hub 209 may be identified with a specific user session when the user session is created. Such an embodiment may designate a keyboard, mouse, monitor, and a connection hub 209 that may be assigned to a single user. When a user logs into a remote session and begins interacting with the remote session server through the local hardware, the user may be able to add and remove peripheral devices from the connection hub 209 during a user session.

In another embodiment, the connection hub 209 may not be assigned to a specific user. In such an embodiment, the assignment of a device from the connection hub 209 to a user session may be made on the fly. In an example, a user may add a peripheral to a connection hub at which point the user may select their user session from the available user sessions. Such a selection may be made with a graphical user interface, a hardware switch, or some other mechanism.

The device 202 may be useful to minimize hardware costs for a multi-user environment. For example, an educational setting may have several user stations for students in a classroom. A single device 202 may provide the user interface hardware, while multiple session servers 232 may be located remotely. The session servers 232 may be located in a datacenter and may execute a separate virtual machine for each user session. In such a use scenario, the school may minimize the number of computers physically in the classroom, which may minimize hardware and administrative costs, which still providing simultaneous and independent access to multiple students.

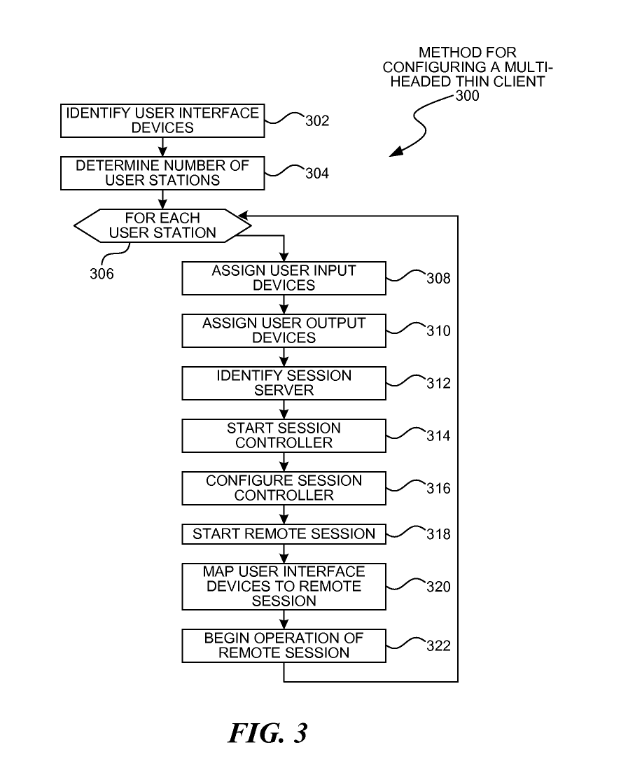

FIG. 3 is a flowchart illustration of an embodiment 300 showing a method configuring a multi-headed thin client. The process of embodiment 300 may be performed during a setup operation for a multi-headed thin client device, such as the devices 102 and 202 of embodiments 100 and 200, respectively.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates a process by which a multi-headed thin client may be configured and may begin operation. The process of embodiment 300 may be performed by an administrator using an administrative application. In many cases, the process of embodiment 300 may be performed automatically when using a configuration file or other predefined options.

In block 302, the user interface devices associated with a multi-headed thin client may be identified and collected. Multi-headed thin client devices may have several sets of user interface devices, and in block 304, the number of user stations may be identified.

For each user station in block 306, the user input devices may be assigned to the user station in block 308. The user input devices may be any device through which the user may input information or data to a session. In block 310, user output devices may be assigned. A typical output device may be a computer monitor, for example. In some cases, a single computer monitor may be shared by two or more users. In such embodiments, a portion of a computer monitor may be mapped to a first user session, while another portion of the same computer monitor may be mapped to a second user session.

In block 312, a session server may be identified for the user station, and the session controller may be started in block 314. The session controller may be an application that executes on the multi-headed thin client system and may manage the user session. The session controller may be configured in block 316, and a remote session may be started in block 318. In block 320, the user interface devices may be mapped to the remote session and the remote session may begin operation in block 322.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a plurality of user interface devices organized into user stations comprising user input devices and user output devices;
for each of said user stations, a session controller that:
establishes a session with a session server;
as part of each session:
receives input from said user input devices, determines a session associated with the user input devices, and transmits said input to said session server associated with said session;
receives output from said session server, determines a session associated with said session server and displays said output from said session server on said user output devices associated with said session.

2. The system of claim 1, at least one of said user stations comprising less than a whole user output device.

3. The system of claim 1, at least one of said user stations comprising a connection point for a peripheral device.

4. The system of claim 1, said session controller that further:
detects said peripheral device connected to said connection point;
establishes a communication session with said peripheral device; and
forwards said communication session to said session controller.

5. The system of claim 4, said connection point being assigned to said session controller prior to said detecting.

6. The system of claim 4, said connection point being assigned to said session controller after said detecting.

7. The system of claim 1, said session server being a virtual machine operable on said system.

8. The system of claim 1, said session server being accessed over a network connection.

9. The system of claim 8, said session controller that further:
compresses communications between said system and said session server.

10. The system of claim 8, said session controller that further:
encrypts communications between said system and said session server.

11. The system of claim 1 further comprising:
an administrative application that:
has a user interface through which an administrator may identify said plurality of user interface devices and assign said user interface devices to said user stations.

12. A method performed by a computer processor, said method comprising:
identifying a plurality of user interface devices;
grouping said plurality of user interface devices into a plurality of user stations comprising user input devices and user output devices;
for each of said user stations, establishing a session with a session server;
as part of each session:
receiving input from said user input devices, determining a session associated with the user input devices, and transmitting said input to said session server associated with said session;
receiving output from said session server, determining a session associated with said session server and displaying said output from said session server on said user output devices associated with said session.

13. The method of claim 12 further comprising:
identifying a peripheral device attached to a connection point;
determining a session server associated with said connection point; and
establishing a connection between said peripheral device and said session server.

14. The method of claim 13 further comprising:
said connection point being associated with said session server prior to said identifying.

15. The method of claim 14, said connection allowing said session server to control said peripheral device.

16. The method of claim 15, said session server that:
identifies said peripheral device;
determines a device type for said peripheral device; and
loads a device driver corresponding to said device type, said device driver being used to control said peripheral device.

17. A system comprising:
a plurality of user stations, each of said user stations comprising at least one user input device and at least one portion of a user output device;
for each of said user stations, an independent session controller that:
establishes a connection with a session server that receives user input and generates user output, said user output comprising a graphical user interface;
receives said user input from said user input device and transmits said user input to said session controller; and
receives said user output from said session controller and displays said user output on said at least one portion of said user output device.

18. The system of claim 17, at least two of said user stations sharing a single user output device.

19. The system of claim 18, said single user output device having a first portion assigned to a first user station and a second portion assigned to a second user station.

20. The system of claim 19, at least four of said user stations sharing said single user output device.
